(19) United States
(12) Patent Application Publication
(10) Pub. No.: US 2026/0019394 A1
(43) Pub. Date: Jan. 15, 2026

(54) SYSTEM AND METHOD FOR CREATING LOCATION-BASED EPHEMERAL CHAT ROOMS USING SHARD-AWARE SERVER ASSIGNMENT

(71) Applicant: Pangeo S.R.L., Santo Domingo (DO)

(72) Inventor: Sebastián Andrés Peña, Santo Domingo (DO)

(73) Assignee: Pangeo S.R.L., Santo Domingo (DO)

(21) Appl. No.: 19/267,160

(22) Filed: Jul. 11, 2025

Related U.S. Application Data
(60) Provisional application No. 63/670,297, filed on Jul. 12, 2024.

(51) Int. Cl. H04L 51/222; G01S 19/14; H04L 51/216

(52) U.S. Cl. CPC H04L 51/222; G01S 19/14; H04L 51/216

(57) ABSTRACT

A system and method for creating and managing ephemeral chat rooms based on users' real-time physical location at predefined geographic Points of Interest (POIs). A mobile device determines user location and transmits a check-in payload to a backend, which assigns the user to a geographically optimized server shard using geohash and distance calculations. Public and private chat rooms are instantiated within the shard, ensuring that all related communication remains local to minimize latency and server load. Chat rooms are automatically deleted upon user checkout, inactivity, or moving a certain distance away from the POI. Friend data is cached within each shard to reduce database queries, and invitations may be issued via QR codes or links. The system achieves scalability and performance by binding location-based sessions to specific backend resources, enabling real-time interaction with significantly reduced computing and storage overhead.

### BACKGROUND OF THE INVENTION

### Field of the Invention

The subject disclosure relates generally to location-based communication systems and, more particularly, to systems and methods for creating and managing ephemeral chat rooms tied to physical geographic locations. The invention further relates to backend infrastructure for efficient handling of location-based user communication through resource-optimized, server-aware design.

### Description of the Related Art

Traditional chat systems, including group messaging applications and social media platforms, are typically designed to be persistent and location-independent. These systems allow users to communicate freely regardless of physical proximity and are often built using centralized or globally distributed architectures that store significant volumes of data—including text, images, and videos—indefinitely. Examples of such architectures include cloud-based messaging platforms that replicate user data across data centers, maintain permanent chat histories, and utilize distributed databases and session-agnostic routing mechanisms. While widely adopted, these architectural models present several technical limitations when applied to real-time, location-sensitive use cases. In particular, they do not leverage geographic proximity for performance optimization, require substantial computing and storage resources to maintain persistent sessions, and lack mechanisms for dynamically associating users and data with localized server environments. These limitations make traditional systems inefficient and ill-suited for ephemeral, proximity-based communication scenarios, such as those addressed by the subject disclosure.

First, conventional chat systems are not designed to optimize for physical proximity between users. All communication must be routed through centralized servers or cloud regions, resulting in unnecessary network hops, increased latency, and inefficient CPU usage. Because users in the same physical space are not guaranteed to communicate via the same server, inter-server traffic increases, leading to additional overhead in message routing and user presence synchronization. Second, conventional architectures require significant computational resources to support high availability and data persistence across distributed systems. Group chat infrastructure often includes redundancy, database replication, media storage, and logging layers. This creates substantial operational complexity, especially when user engagement is transient and tied to short-lived physical presence at specific locations, such as events, retail spaces, or social venues. Third, conventional systems maintain long-lived data footprints even when communication is no longer relevant. Messages, media, and metadata persist indefinitely unless explicitly deleted. This leads to rapid storage consumption, particularly in group chats that accumulate large volumes of multimedia content. Such persistent data retention is unnecessary and inefficient for use cases focused on ephemeral interaction tied to real-world presence. Additionally, most messaging platforms are not developed to take advantage of the fact that certain chats, such as those tied to a location, will naturally involve users who are physically near one another. They do not leverage this to reduce load on the backend, minimize inter-node communication, or strategically partition compute resources. As a result, even location-inspired applications must fall back on general-purpose messaging infrastructure that scales poorly and consumes excessive resources.

Accordingly, there is a need for a system that supports real-time, location-based chat experiences while reducing backend server load, inter-server network traffic, and overall storage consumption. Such a system should leverage users' physical proximity to intelligently route communication, bind users to geographically appropriate compute clusters through the use of sticky sessions, and automatically purge ephemeral conversations when they are no longer active. These and other improvements are addressed by the present disclosure.

### SUMMARY OF THE DISCLOSURE

The subject disclosure relates to a system and method for creating and managing ephemeral chat rooms based on users' geographic proximity to predefined locations. The system assigns virtual GPS coordinates to backend servers or server clusters, each responsible for managing chat activity within a specific geographic area. When a new chat room is created, the system determines the physical location of the associated Point of Interest (POI) and calculates the distance between that location and the virtual coordinates of each available server. A Haversine formula is applied to compute geographic distances accurately. The server with the shortest computed distance is selected to host the chat room, ensuring that user traffic is routed to the server closest to the location, thereby minimizing latency and reducing inter-server communication. To maintain session consistency and optimize resource usage, the system employs a sticky-session mechanism. Once a user joins a chat room, all subsequent communication from that user is consistently routed to the same server using a lookup table indexed by server ID and user ID. This eliminates the need for session replication or distributed routing logic. Chat rooms are automatically deleted under defined conditions, such as when there is no activity for a predetermined period, when all users manually check out, or when all users move beyond the defined geographic boundary. This deletion policy ensures that server resources—both computational and network-related—are used efficiently and are promptly reclaimed when no longer needed. Through this architecture, the invention provides a scalable, location-sensitive chat platform that dynamically assigns and manages sessions in a manner that improves backend efficiency, minimizes latency, and supports real-world social interaction.

Particularly, the subject disclosure relates to a system for creating and managing location-based ephemeral chat rooms, comprising at least one mobile computing device comprising a processor, memory, a GPS receiver, and a network interface, the mobile computing device configured to: determine geographic coordinates of a user; and transmit a check-in request comprising the geographic coordinates and a user identifier. Wherein the system further comprises a backend infrastructure comprising a plurality of server clusters, each assigned a predefined virtual geographic location represented in a geographic coordinate system, and each server cluster configured to operate as a compute shard responsible for managing user sessions and chat activity within a corresponding geographic region. Wherein the system further comprises a shard manager configured to: receive the check-in request; calculate a geographic distance between the geographic coordinates and each server cluster's virtual geographic location using a great-circle distance formula, wherein the great-circle distance is calculated based on a Haversine formula comprising: (i) determining the difference in latitude and longitude between the two coordinate sets, (ii) applying trigonometric functions to compute an angular distance, and (iii) multiplying the angular distance by the radius of Earth to obtain a linear distance between the user's location and each server cluster. Wherein the system is further configured to select a server cluster with a shortest calculated distance; and assign the check-in request to the selected server cluster; wherein the selected server cluster configured to: instantiate a chat room associated with a predefined geographic location if one does not exist; route all user communication associated with the chat room through the selected server cluster; maintain a lookup table associating the user identifier with a server identifier to enforce session affinity for the duration of the session; and wherein the chat room is configured to be automatically deleted based on one or more criteria comprising user departure from the geographic location, expiration of a time interval, or inactivity of participants.

Lastly, the subject disclosure is directed to a computer-implemented method for creating and managing location-based ephemeral chat rooms, the method comprising: determining, by a mobile computing device, a geographic location of a user based on GPS coordinates; transmitting, from the mobile computing device, a check-in request to a backend system, the check-in request comprising the geographic location and a user identifier; receiving, by a shard manager of the backend system, the check-in request; calculating, by the shard manager, a geographic distance between the geographic location of the user and each of a plurality of predefined virtual geographic locations, each virtual geographic location being associated with a corresponding server cluster, wherein calculating the geographic distance comprises: determining a difference in latitude and longitude between the geographic location of the user and each virtual geographic location; (i) applying trigonometric functions to compute an angular distance based on the latitude and longitude differences; and (ii) multiplying the angular distance by the radius of Earth to obtain a linear distance between the user's location and each server cluster. Wherein the method further comprises selecting, by the shard manager, a server cluster having a shortest calculated distance from the user's geographic location; assigning, by the shard manager, the check-in request to the selected server cluster; instantiating, by the selected server cluster, a chat room associated with a predefined geographic location if a corresponding chat room does not already exist; routing, by the backend system, user communication related to the chat room exclusively through the selected server cluster; storing, in a lookup table, an association between the user identifier and a server identifier of the selected server cluster to enforce session affinity; and automatically deleting the chat room based on one or more criteria comprising: (i) user departure from a geofenced area associated with the predefined geographic location, (ii) expiration of a predefined time period, or (iii) inactivity of all participants in the chat room.

A novel feature of the subject disclosure is the integration of a location-aware, shard-based server assignment mechanism that enables geographically bounded chat sessions to be handled entirely within the nearest available compute cluster. This architecture represents a specific improvement in the functioning of computer systems by reducing the number of network hops, eliminating unnecessary inter-node communication, and maintaining session state within a localized processing unit. Unlike conventional messaging platforms that rely on globally distributed routing and session replication, often requiring substantial CPU, memory, and bandwidth, the disclosed system ties chat room activity to a regionally optimized backend environment based on real-time GPS data and distance-based calculations. As a result, the system reduces latency, lowers computational overhead, and minimizes storage use by dynamically creating and deleting chat rooms based on user presence and activity within a defined geographic area.

### BRIEF SUMMARY OF THE DRAWINGS

FIG. 1 shows a flowchart of the steps for creating location-based ephemeral chat rooms using shard-aware server assignment.

### DETAILED DESCRIPTION OF THE DISCLOSURE

The present disclosure relates to a computer-implemented system and method for dynamically creating and managing temporary chat rooms based on a user's physical presence at predefined geographic locations, referred to as Points of Interest (POIs). This system operates as a location-aware communication platform designed to designed to encourage real-world social interaction while leveraging backend infrastructure optimized for performance, scalability, and resource efficiency.

The system includes at least one mobile computing device, such as a smartphone or tablet, comprising a processor, system memory, a GPS receiver, a network interface (e.g., 5G or Wi-Fi), and a touchscreen display. The device executes a mobile application stored in non-volatile memory. The application includes software modules such as a user interface manager, a GPS polling module that retrieves location data at configurable intervals, a check-in handler that formats and signs geolocation payloads, and a messaging client that communicates with a backend infrastructure using real-time protocols such as WebSocket or gRPC.

When a user activates the check-in function, the mobile application determines the current geographic coordinates of the device using the GPS module. These coordinates are then compared to a list of known POIs. If the device is within the predefined radius of a POI, the application generates a signed payload that includes the user's unique ID, the current coordinates, and the POI identifier. This payload is transmitted to a backend edge load balancer, which routes the request to a geographically optimized backend server cluster.

To scale the system horizontally and efficiently allocate compute resources, the system employs a POI-based sharding strategy, which involves dividing the backend infrastructure into multiple independent units called shards, each responsible for handling a specific subset of geographic regions. In this architecture, each server cluster is assigned a fixed virtual coordinate within a geographic coordinate system, which serves as a reference point for proximity-based routing decisions. These predefined virtual locations are used to determine which shard is closest to a user or POI at runtime. Each shard is associated with one of these virtual coordinates or a designated set of POIs, and is responsible for processing chat room activity and managing local state within its assigned region. This strategy ensures that user requests are routed to the most relevant server cluster based on physical proximity. When a user attempts to check in to a POI, a backend service called the shard manager converts the user's GPS coordinates into a compact geographic hash (geohash) and performs a Haversine distance calculation to determine the distance between the user's location and the predefined virtual coordinate of each shard. The term “predefined” as used herein refers to values that are assigned prior to runtime, such as during system configuration, deployment, or initialization. “As used herein, a ‘geographic coordinate system’ refers to a spatial reference framework that enables representation of positions on Earth's surface, typically using latitude and longitude values based on a spheroidal model such as WGS 84. As used herein, a ‘server cluster’ refers to a group of physically or logically connected compute nodes that collectively host backend services such as chat room management, presence tracking, and data caching. Each server cluster may include one or more processing environments capable of executing containerized or virtualized microservices.”

The shard manager then selects the shard with the smallest calculated distance and assigns the session to that shard. As a result, all communication related to that user's session, such as chat messages, presence updates, and friend interactions, occurs within the geographically closest shard, thereby reducing network latency, minimizing server-to-server communication, and optimizing resource usage. Each shard is implemented as a self-contained compute cluster comprising a dedicated set of processing environments, which host a suite of microservices responsible for handling user activity within a specific geographic region. These microservices include, but are not limited to, a Chat Room Service (for instantiating and managing chat rooms), a Presence Service (for tracking active users within POIs), and a Friend Cache API (for delivering user-specific friend list data and associated metadata). Each shard functions as an autonomous compute and data zone, maintaining the state and session data required to support users within a bounded group of Points of Interest (POIs). Because all necessary services and data are co-located within the same shard, the system eliminates the need for cross-shard communication during active sessions. This architecture enables the platform to horizontally scale by simply deploying additional shards as user demand or geographic coverage grows. Moreover, by assigning users to shards based on physical proximity, the system ensures that communication occurs within the nearest server cluster, thereby minimizing network latency, reducing inter-server traffic, and providing a responsive, location-aware user experience.

The Haversine algorithm is used to compute the distance between the user's location and the virtual GPS coordinates of each shard. The system selects the shard associated with the smallest computed distance and instantiates the new chat room within that shard. This localized processing ensures that all messaging, presence tracking, and data lookups for users in that chat session are handled within the same physical server group. As a result, the system reduces inter-server hops, optimizes CPU cycles by eliminating distributed message routing, and decreases operational costs.

The Haversine algorithm computes great-circle distance between two geographic points using the following steps (implemented in Python):

$$from math import radians , sin , cos , sqrt , atan 2$$

$$def haversine\_distance ( lat 1 , lon 1 , lat 2 , lon 2 ) :$$

$$R = 6371 \# Earth radius in km$$

$$dLat = radians ( lat 2 - lat 1 )$$

$$dLon = radians ( lon 2 - lon 1 )$$

$$lat 1 = radians ( lat 1 )$$

$$lat 2 = radians ( lat 2 )$$

$$a = sin ( dLat / 2 ) ** 2 + cos ( lat 1 ) * cos ( lat 2 ) * sin ( dLon / 2 ) ** 2$$

$$c = 2 * atan 2 ( sqrt ( a ) , sqrt ( 1 - a ) )$$

$$return R * c$$

To further reduce backend load, the system implements sticky sessions, a technique in which each user is consistently routed to the same backend server for the duration of their session. Once a user joins a chat room, all subsequent traffic (such as messaging, presence updates, and data requests) is directed to the same shard or server instance that instantiated the chat room. This eliminates the need for inter-server coordination or session replication, thereby reducing latency, network hops, and CPU usage. To facilitate sticky session management, the system maintains a lookup table indexed by SERVER_ID and USER_ID, ensuring that routing decisions remain consistent across requests. Additionally, this table may store cached user data in a structured format such as JSON. For example:

```
{
  “user_id”: 123,
  “user”: “fooUser”,
  “user_name”: “John Doe”,
  “user_friends”: 22
}
```

The stored data includes user ID, username, display name, and number of friends, and is associated with a USER_DATA_DIRTY flag used to track stale entries. When profile data is modified, background processes asynchronously refresh the cache entries for affected users. This approach eliminates frequent calls to external databases to retrieve basic user information and drastically reduces read operations, especially during friend list population.

Once routed to a shard, the backend checks whether a public chat room already exists for the POI. If not, it creates one. A private chat room is also instantiated and associated with the initiating user. The user may then invite friends to the private room using in-app notifications, scannable QR codes, or shareable links. Invitations may be configured with expiration time limits and access restrictions, particularly for invited users who are not physically located within the POI. Such restrictions may include limited session durations or reduced messaging capacity, which incentivizes physical presence without fully excluding remote interaction. Public chat rooms are only accessible to users whose devices report GPS coordinates within the defined radius around the POI. Private chat rooms are tethered to the user's session and are automatically deleted once the user checks out. Check-out may occur manually, based on GPS departure from the POI, after a period of inactivity, or in accordance with POI-specific business hours.

To conserve system resources, chat rooms—both public and private—are ephemeral by design. If a room becomes inactive or all users leave, it is deleted from the system. This significantly reduces the memory and storage footprint compared to conventional chat platforms, which typically retain group history indefinitely. Furthermore, because the system intentionally avoids support for image or video file transfers, and deletes rooms once a user departs a location, the system's storage usage per chat room is reduced to a few kilobytes. In contrast, traditional chat applications often consume 1-50 GB of data per user over time. By eliminating media storage and aggressively purging stale data, the system achieves 2-3 orders of magnitude in storage savings and operates at only 0.1%-1% of the resource load typical in competing systems.

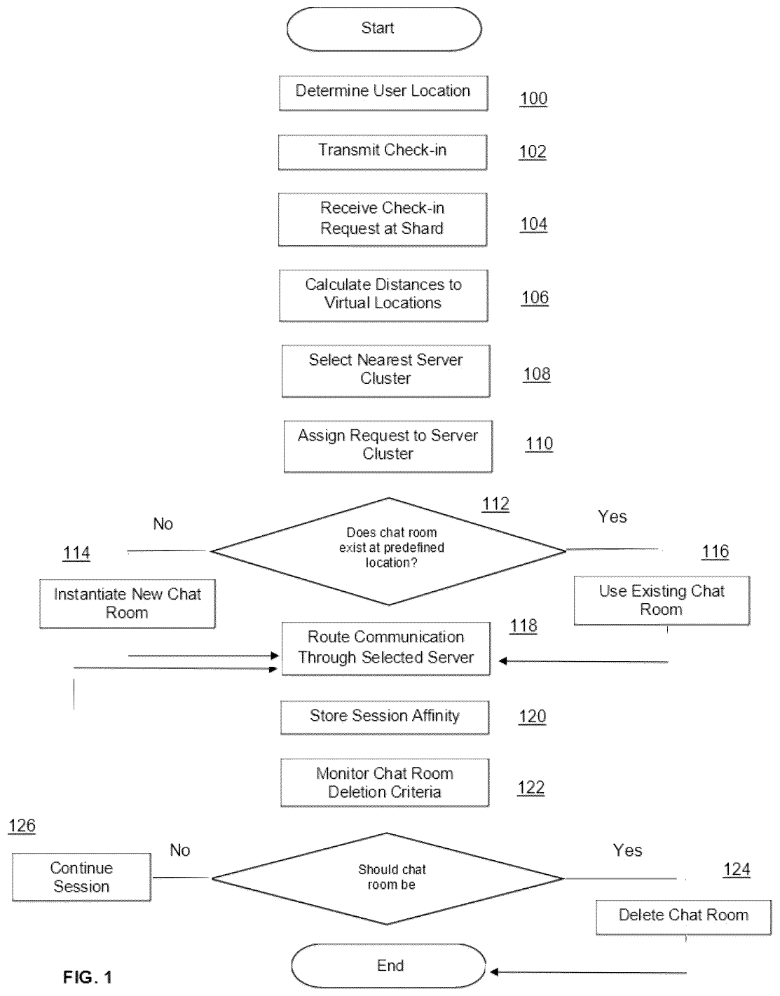

FIG. 1 is a flowchart illustrating the computer-implemented method for creating and managing location-based ephemeral chat rooms, described above. The method begins by determining a user's geographic location using GPS 100, followed by transmitting a check-in request including the location and user identifier to a backend system 102. A shard manager receives the check-in request 104 and calculates the geographic distance between the user's location and multiple predefined virtual locations 106, which includes computing latitude and longitude differences, applying trigonometric functions, and multiplying the resulting angular distance by the radius of the Earth. The shard manager selects the nearest server cluster based on the calculated distances 108 and assigns the check-in request to the selected server cluster 110. The method continues by determining whether a chat room exists at the predefined location 112. If a chat room does not exist, a new chat room is instantiated 114; otherwise, the system proceeds using the existing chat room 116. User communications are then routed exclusively through the selected server cluster 118. The backend system stores an association between the user identifier and the selected server cluster to enforce session affinity 120. The method further includes monitoring the chat room for deletion criteria 122, which may include user departure from a geofenced area, expiration of a predefined time period, or inactivity of all chat room participants. If any deletion condition is met, the chat room is automatically deleted 124; otherwise, the session continues 126.

In an alternate implementation, the system may allow users to create private chat rooms at a geographic location (i.e., a POI) and invite participants who are not physically present at the location. In such embodiments, the private chat room remains active only as long as the user who created the chat remains within the POI's defined geofence. Once the initiating user physically moves beyond the POI boundary—whether through manual checkout, automatic GPS-based checkout, or inactivity—the associated private chat room is deleted. This behavior ensures that all resource-saving mechanisms described herein, including ephemeral session management and automatic data purging, remain in effect regardless of whether remote participants were temporarily included in the session.

In another alternate implementation, the system may support long-lived or semi-permanent chat rooms tied to locations with continuous or 24-hour activity, such as airports, transit hubs, or convention centers. To prevent unchecked accumulation of chat data, the system may combine user-based check-out mechanisms (e.g., departure from the POI) with a message expiration policy. Specifically, any message posted by a user who has since checked out of the location may be automatically deleted after a predefined retention window (e.g., 24 hours). In this embodiment, a background batch process may be executed at regular intervals (such as hourly) to iterate over all active chat rooms and delete messages older than the defined expiration period.

This design ensures that the size of each chat room remains bounded and proportional to the number of users currently active within the POI, preventing exponential growth in message storage and supporting continued savings in computational and networking resources. The batch process may be implemented as a scheduled task that performs the following: (1) retrieve a list of all active chat rooms; and (2) for each active room, delete all messages older than the configured threshold (e.g., 24 hours). This deletion policy reinforces the system's emphasis on in-person interaction and short-lived digital engagement.

The system is thus not intended to serve as a persistent geo-based chat archive, but rather as a lightweight discovery and interaction layer that promotes real-world social connection. Users who wish to continue conversations beyond the geographic context of the POI are free to transition to other communication platforms outside the scope of the present invention. This design choice further supports the system's architectural goals of minimal storage usage, low infrastructure cost, and ephemeral, location-sensitive user experience.

What is claimed is:

1. A system for creating and managing location-based ephemeral chat rooms, comprising:
at least one mobile computing device comprising a processor, memory, a GPS receiver, and a network interface, the mobile computing device configured to:
determine geographic coordinates of a user;
transmit a check-in request comprising the geographic coordinates and a user identifier;
a backend infrastructure comprising a plurality of server clusters, each assigned a predefined virtual geographic location represented in a geographic coordinate system, and each server cluster configured to operate as a compute shard responsible for managing user sessions and chat activity within a corresponding geographic region;
a shard manager configured to:
receive the check-in request;
calculate a geographic distance between the geographic coordinates and each server cluster's virtual geographic location using a great-circle distance formula, wherein the great-circle distance is calculated based on a Haversine formula comprising:
(i) determining the difference in latitude and longitude between the two coordinate sets,
(ii) applying trigonometric functions to compute an angular distance, and
(iii) multiplying the angular distance by the radius of Earth to obtain a linear distance between the user's location and each server cluster;
select a server cluster with a shortest calculated distance; and
assign the check-in request to the selected server cluster;
wherein the selected server cluster configured to:
instantiate a chat room associated with a predefined geographic location if one does not exist;
route all user communication associated with the chat room through the selected server cluster;
maintain a lookup table associating the user identifier with a server identifier to enforce session affinity for the duration of the session;
wherein the chat room is configured to be automatically deleted based on one or more criteria comprising user departure from the geographic location, expiration of a time interval, or inactivity of participants.

2. The system of claim 1, wherein each server cluster comprises a plurality of processing environments hosting microservices including a chat room service, a presence service, and a friend cache API.

3. The system of claim 1, wherein the lookup table is indexed by a server identifier and a user identifier, and further comprises a data field storing user metadata in JSON format.

4. The system of claim 3, wherein the user metadata comprises at least one of: user ID, display name, nickname, friend count, and a profile image URL.

5. The system of claim 3, wherein the lookup table includes a flag indicating whether the user metadata is stale, and wherein the system comprises a background process to asynchronously update stale metadata.

6. The system of claim 1, wherein the chat room is one of a public chat room accessible to users located within a predefined radius of the geographic location or a private chat room accessible only to invited users.

7. The system of claim 6, wherein the private chat room is deleted upon the initiating user departing the geographic location.

8. The system of claim 1, wherein users are invited to join private chat rooms via one or more of: in-app notifications, QR codes, or shareable hyperlinks.

9. The system of claim 1, wherein a background task executes periodically to delete messages older than a predetermined retention period from chat rooms associated with high-traffic or long-lived POIs.

10. The system of claim 1, wherein the chat room is implemented as an ephemeral data structure stored in memory and not persistently retained after deletion.

11. A computer-implemented method for creating and managing location-based ephemeral chat rooms, the method comprising:
determining, by a mobile computing device, a geographic location of a user based on GPS coordinates;
transmitting, from the mobile computing device, a check-in request to a backend system, the check-in request comprising the geographic location and a user identifier;
receiving, by a shard manager of the backend system, the check-in request;
calculating, by the shard manager, a geographic distance between the geographic location of the user and each of a plurality of predefined virtual geographic locations, each virtual geographic location being associated with a corresponding server cluster, wherein calculating the geographic distance comprises:
(i) determining a difference in latitude and longitude between the geographic location of the user and each virtual geographic location;
(ii) applying trigonometric functions to compute an angular distance based on the latitude and longitude differences; and
(iii) multiplying the angular distance by the radius of Earth to obtain a linear distance between the user's location and each server cluster;
selecting, by the shard manager, a server cluster having a shortest calculated distance from the user's geographic location;
assigning, by the shard manager, the check-in request to the selected server cluster;
instantiating, by the selected server cluster, a chat room associated with a predefined geographic location if a corresponding chat room does not already exist;
routing, by the backend system, user communication related to the chat room exclusively through the selected server cluster;
storing, in a lookup table, an association between the user identifier and a server identifier of the selected server cluster to enforce session affinity;
and automatically deleting the chat room based on one or more criteria comprising:
(i) user departure from a geofenced area associated with the predefined geographic location,
(ii) expiration of a predefined time period, or
(iii) inactivity of all participants in the chat room.

12. The method of claim 11, wherein the check-in request is formatted as a JSON payload and comprises at least a user identifier, the geographic location, and a digital signature.

13. The method of claim 11, further comprising storing, in a lookup table, an association between the user identifier and a server cluster identifier to maintain session affinity, such that all user communication for the session is routed to the same server cluster.

14. The method of claim 11, further comprising caching, within the selected server cluster, user-specific friend data including friend identifiers and profile image URLs, and retrieving such data from a local in-memory key-value store during chat room participation.

15. The method of claim 11, further comprising setting a flag in a lookup table indicating that user metadata is stale, and executing, by the backend system, a background process that asynchronously updates the stale metadata from a persistent data source.

16. The method of claim 11, wherein the chat room is a private chat room created by the user and is automatically deleted upon the user departing the geographic location.

17. The method of claim 11, wherein the chat room is a public chat room accessible only to users located within a predefined geofenced area surrounding a point of interest.

18. The method of claim 11, further comprising periodically executing a background process configured to delete messages from the chat room that are older than a predefined retention period.
